(19) United States
(12) Patent Application Publication
(10) Pub. No.: US 2005/0065285 A1
(43) Pub. Date: Mar. 24, 2005

(54) Compositions with poly(ethynylene phenylene ethynylene silylenes)

(76) Inventors: Pierrick Buvat, Montbazon (FR); Franck Jousse, Tovas (FR); Fabien Nony, Monts (FR); Jean-Francois Gerard, Bron (FR)

Correspondence Address: Burns Doane Swecker & Mathis, 1737 King Street #400, Alexandria, VA, 22314-2727, US

(21) Appl. No.: 10/490,523

(22) PCT Filed: Mar. 6, 2003
(86) PCT No.: PCT/FR03/00720

(30) Foreign Application Priority Data
Mar. 6, 2002 (FR) 02/02952

(51) Int. Cl. C08F 8/00; C08L 63/00

(52) U.S. Cl. 525/100; 525/178; 525/192; 525/123; 525/107

(57) ABSTRACT

Composition comprising a blend of at least one poly(ethynylene phenylene ethynylene silylene) polymer and of at least one compound capable of exerting a plasticizing effect in the blend, once this blend has been cured.

The present invention relates to compositions comprising polymers of poly(ethynylene phenylene ethynylene silylene) type.

The invention also relates to the cured products that may be obtained by heat-treating said compositions.

The polymer compositions according to the invention may be used especially in matrices for composites.

The technical field of the present invention may be defined as that of heat-stable plastics, i.e. polymers that can withstand high temperatures that may, for example, be up to 600° C.

The industrial needs for such heat-stable plastics have increased enormously in recent decades, in particular in the electronics and aerospace fields.

Such polymers have been developed to overcome the drawbacks of the materials previously used in similar applications.

Specifically, it is known that metals such as iron, titanium and steel have very high heat resistance, but they are heavy. Aluminium is light, but has low heat resistance, i.e. up to about 300° C. Ceramics such as SiC, Si₃N₄ and silica are lighter than metals and very heat-resistant, but they are not mouldable. It is for this reason that many plastics have been synthesized, which are light, mouldable and have good mechanical properties; they are essentially carbon-based polymers.

Polyimides have the highest heat resistance of all plastics, with a thermal deformation temperature of 460° C.; however, these compounds, which are listed as being the most stable currently known, are very difficult to use. Other polymers such as polybenzimidazoles, polybenzothiazoles and polybenz-oxazoles have even higher heat resistance than that of polyimides, but they are not mouldable and are flammable.

Silicon-based polymers such as silicones or carbosilanes have also been intensively studied. These polymers, such as poly(silylene ethynylene) compounds, are generally used as precursors of ceramics of silicon carbide SiC type, reserve compounds and conductive materials.

It has recently been shown in document [4] that poly[(phenyl silylene) ethynylene-1,3-phenylene ethynylene] (or MSP), prepared by a synthetic process involving polymerization reactions by dehydrocoupling between phenylsilane and m-diethynylbenzene, have remarkably high heat stability. This is confirmed in document [1], which more generally demonstrates the excellent heat-stability properties of poly(silylene ethynylene phenylene ethynylenes) which comprise a repeating unit represented by formula (A) below:

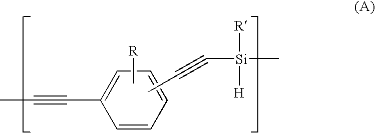

The synthesis of polycarbosilanes comprising a silane function and a diethynylbenzene via standard processes using metal catalysts leads to polymers of low purity containing large traces of metal catalyst, which greatly impair their thermal properties.

Other improved synthetic processes are presented in document [2]: these are palladium-catalyzed syntheses, but they apply only to a very limited number of specific polymers in which the silicon bears two phenyl or methyl groups, for example.

In particular, it will be noted that the compounds whose repeating unit has been described above by formula (A) cannot be synthesized by this process. It is found that the SiH bonds of such compounds that are particularly difficult to obtain are very advantageous since they are extremely reactive and can give rise to numerous rearrangements and reactions.

Another process of cross-dehydrocoupling or polycondensation of silanes with alkynes in the presence of a catalytic system based on copper chloride and an amine is described in document [3]. However, this process is also limited to a few polymers and results in compounds whose structure is partially crosslinked and whose mass-average molecular weight is very high (10⁴ to 10⁵).

These structural defects seriously impair both the solubility properties and the thermal properties of these polymers.

Another synthetic process that is directed towards overcoming the drawbacks of the processes described above, and towards preparing pure compounds, without traces of metals, and with excellent and well-defined properties, especially in terms of heat stability, was proposed in the abovementioned document [4]. This process essentially allows the synthesis of the compounds of formula (A) above in which the silicon bears a hydrogen atom. The process according to [4] is a polycondensation by dehydrogenation of a functionalized hydrosilane with a compound of diethynyl type in the presence of a metal oxide such as MgO, according to the reaction scheme (B) below:

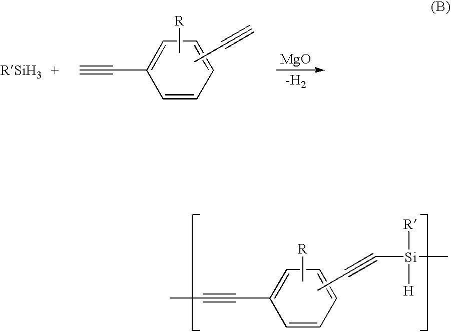

This process leads to weakly crosslinked polymers having, as represented above, excellent heat stability, but whose mass distribution is, however, very broad.

In another, more recent publication [1], the same authors prepared a series of polymers comprising the —Si(H)—C≡C— unit via process (B) and via another more advantageous process, involving the condensation reaction of dichlorosilane and of diethynylene organomagnesium reagents followed by reaction of the product obtained with a monochlorosilane, followed by a hydrolysis, according to the reaction scheme (C) below:

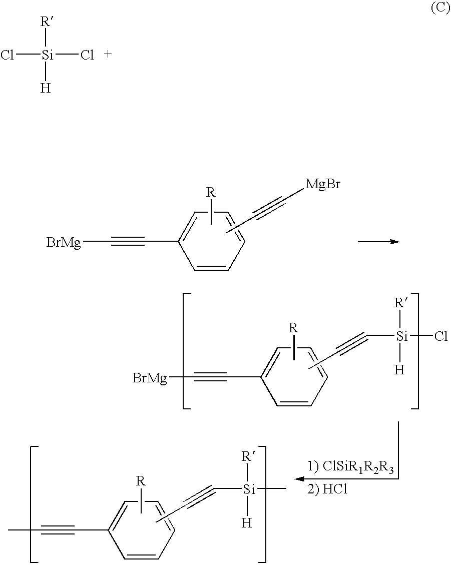

In contrast with process (B), process (C) allows the production of polymers without structural defects, with good yields and a low mass distribution.

The compounds obtained by this process are totally pure and have fully characterized thermal properties. They are thermosetting polymers.

Said document also discloses the preparation of the polymers mentioned above reinforced with glass, carbon or SiC fibres.

A patent relating to polymers comprising the very general repeating unit (D): 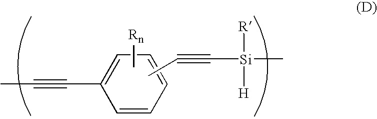
in which R and R′ are numerous groups known in organic chemistry, was granted to the authors of documents [1] and [4]; this is document EP-B1-0 617 073 (corresponding to American patent U.S. Pat. No. 5,420,238).

These polymers are prepared essentially by the process of scheme (C) and possibly by the process of scheme (B), and they have a weight-average molecular mass from 500 to 1 000 000. Said document also describes cured products based on these polymers and their preparation by a heat treatment. It is indicated that the polymers in said document can be used as heat-stable polymers, fire-resistant polymers, conductive polymers, and materials for electroluminescent elements. In fact, it appears that such polymers are essentially used as organic precursors of ceramics.

The excellent heat stability of the polymers prepared especially in document EP-B1-0 617 073 makes them capable of constituting the resin forming the organic matrix of heat-stable composite materials.

Many techniques for producing composites exist.

In very general terms, the various processes involve injection techniques (especially RTM) or prepreg compacting techniques.

Prepregs are semi-finished products, of low thickness, consisting of fibres impregnated with resin. Prepregs that are intended for producing high-performance composite structures contain at least 50% fibre by volume.

Also, during use, the matrix will have to have a low viscosity in order to penetrate the reinforcing sheet and correctly impregnate the fibre so as to prevent it from distorting and conserve its integrity. Reinforcing fibres are impregnated either with a solution of resin in a suitable solvent, or with the pure resin melt; this is the “hot-melt” technique. The technology for manufacturing prepregs with a thermoplastic matrix is substantially governed by the morphology of the polymers.

Injection-moulding is a process that consists in injecting the liquid resin into the textile reinforcing agent positioned beforehand in the imprint consisting of the mould and the counter-mould. The most important parameter is the viscosity, which must be between 100 and 1000 mPa.s at the injection temperature, which is generally from 50 to 250° C.

For these two techniques, the viscosity is thus the critical parameter, which conditions the ability of the polymer to be used.

Amorphous polymers correspond to macromolecules with a totally disordered skeleton structure. They are characterized by their glass transition temperature (Tg) corresponding to the change from the vitreous state to the rubbery state. Above the Tg, the thermoplastics are characterized, however, by great creep strength.

The polymers prepared in document EP-B1-0 617 073 are compounds that are in powder form. The inventors have shown, by reproducing the syntheses described in said document, that the polymers prepared would have glass transition temperatures in the region of 50° C.

Below this temperature, the viscosity of the polymer is infinite, and above this temperature, the viscosity decreases gradually as the temperature is increased.

However, this drop in viscosity is not sufficient for the polymer to be able to be used in processes conventionally used in the field of composites such as RTM and preimpregnation, already described above.

Document FR-A-2 798 662 from Buvat et al. describes polymers with a structure similar to that of the polymers described in patent EP-B1-0 617 073, i.e. which have all their advantageous properties, especially heat stability, but whose viscosity is low enough to allow them to be used and processed at temperatures, for example, of from 100 to 120° C., which are the temperatures commonly used in injection or impregnation techniques.

These polymers, described in document FR-A-2 798 662, correspond to formula (I) below: 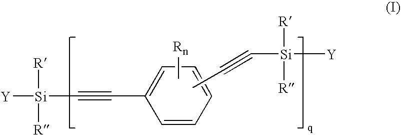
or to formula (Ia) below:

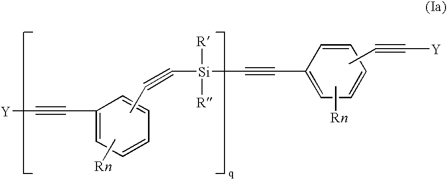

Reference may be made to document FR-A-2 798 662 for the meaning of the various symbols used in these formulae. It is important to note that the polymers according to FR-A-2 798 662 are substantially similar in structure to the polymers of document EP-B1-0 617 073, with the fundamental exception, however, of the presence at the chain ends of groups Y derived from a chain-limiting agent. The heat-stable polymers of FR-A-2 798 622 have fully defined and regulable Theological properties, which allows their use as matrices for heat-stable composites. The set of properties of these polymers is described in FR-A-2 798 622, to which reference may be made.

Document FR-A-2 798 622 also describes a process for synthesizing these heat-stable polymers. The technique developed makes it possible to adjust as desired, as a function of the technological working constraints of the composite, the viscosity of the polymer. This property is intimately linked to the molecular mass of the polymer. Low viscosities are observed on polymers of low molecular mass. Control of the masses is obtained by adding to the reaction medium a reactive species that blocks the polymerization reaction without affecting the overall reaction yield. This species is an analogue of one of the two reagents used to synthesize the polymer, but bearing only one function allowing coupling. When this species is introduced into the polymer chain, growth is stopped. The length of the polymer is then easily controlled by means of dosed additions of chain limiter. A detailed description of the processes for synthesizing the polymers described above is given in document FR-A-2 798 622, to which reference may be made.

Moreover, since the prepolymers prepared both in Itoh document EP-B1-0 617 073 and in Buvat document FR-A-2 798 622 are heat-setting, the crosslinking of these materials is heat-activated.

The reactions involved in this phenomenon mainly involve two mechanisms, which are described in an article published by Itoh [5].

The first mechanism is a Diels-Alder reaction, involving an acetylenic bond coupled to an aromatic nucleus, on the one hand, and another aromatic bond, on the other hand. This reaction may be illustrated in the following manner:

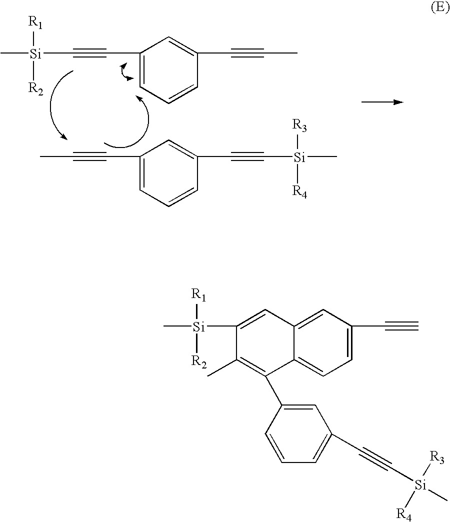

This reaction generates a naphthalene unit. It can take place irrespective of the nature of R₁, R₂, R₃ or R₄.

The structures obtained by this mechanism are thus highly aromatic and comprise many unsaturated bonds. These characteristics are the source of the excellent thermal properties observed for these polymers.

The second mechanism, which takes place during the crosslinking reaction of the poly(ethynylene phenylene ethynylene silylene) prepolymers, is a hydrosilylation reaction, involving the SiH bond and an acetylenic triple bond. This reaction may be illustrated in the following manner:

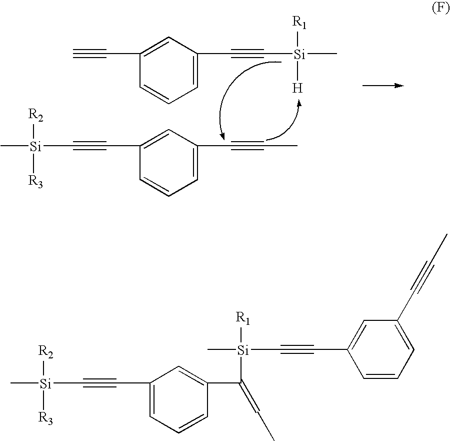

This reaction takes place only for compounds whose silicon bears the SiH bond.

For the latter compounds, the hydrosilylation reaction is activated in the same temperature ranges as the Diels-Alder reactions.

A polymer network is, inter alia, defined by the crosslinking density and by the length of the chain units that separate two crosslinking points. These characteristics predominantly govern the mechanical properties of the polymers. Thus, highly crosslinked networks with short chain units are classified in the range of materials with low deformability. Phenolic resins or phenolic cyanate ester resins especially form part of this category of materials.

In the case of poly(ethynylene phenylene ethynylene silylenes), the crosslinking involves the acetylenic triple bonds, simply separated by an aromatic nucleus. Consequently, the crosslinking density is very high and the inter-node chain units are very short. Cured materials based on poly(ethynylene phenylene ethynylene silylenes) are consequently among the polymer matrices with low deformability.

The crosslinking density may be controlled during the use of the polymer via suitable heat treatments. Specifically, the crosslinking of the polymer stops when the mobility of the macromolecular chains is no longer sufficient. It is accepted that this mobility is sufficient once the working temperature is above the glass transition temperature of the network. Consequently, the glass transition temperature cannot exceed the working temperature, and the crosslinking density is thus controlled by the curing temperature of the polymer.

However, under-crosslinked materials are unstable materials whose use, at temperatures above the working temperature, will give rise to a change in the structure.

The mechanical properties of poly(ethynylene phenylene ethynylene silylenes) are, consequently, difficult to regulate via heat treatment. However, the nature of the chemical groups borne by the silicon is capable of regulating these properties. Specifically, long chains may act as plasticizers and reduce the rigidity of the associated materials. However, this principle encounters limits in terms of the heat stability of the polymer, since this stability is then affected.

There is thus a need for a polymer, or rather for a composition comprising a polymer of poly(ethynylene phenylene ethynylene silylene) type, which, while displaying all the advantageous properties of these polymers, and of the compositions comprising these copolymers, especially in terms of heat stability, also has regulable, improved mechanical properties.

There is still a need for compositions comprising polymers of poly(ethynylene phenylene ethynylene silylene) type, which give by heat-treatment cured products whose mechanical properties are improved and, in particular, whose fragility, brittle nature and hardness are reduced, and, in contrast, whose flexibility and suppleness are increased.

These mechanical properties must be obtained without affecting the other advantageous properties of these cured products, in particular, once again, in terms of heat stability.

Furthermore, preferably, this polymer and the composition comprising it must have a viscosity that is low enough for it to be usable, manipulable or “processable” at temperatures of, for example, 100 to 120° C., which are the temperatures commonly used in injection or impregnation techniques.

The aim of the present invention is to provide compositions of polymers of poly(ethynylene phenylene ethynylene silylene) type that satisfy these needs, inter alia, which do not have the defects, drawbacks, limitations and disadvantages of the polymer compositions of the prior art as represented in particular by documents EP-B1-0 617 073 and FR-A-2 798 622, and which solve the problems of the prior art.

This aim, and others, are achieved in accordance with the invention by means of a composition comprising the blend of at least one poly(ethynylene phenylene ethynylene silylene) polymer and of at least one compound capable of exerting a plasticizing effect in the blend, once this blend has been cured. Compositions comprising the blend of a specific poly(ethynylene phenylene ethynylene silylene) polymer and of a compound capable of exerting a plasticizing effect in the blend, once this blend has been cured, are not described in the prior art.

The preparation of a specific blend comprising, besides a poly(ethynylene phenylene ethynylene silylene) polymer, a compound capable of exerting a plasticizing effect in the blend once the blend has been cured, leads, specifically and surprisingly, to compounds or cured products whose mechanical properties are greatly improved compared with the cured products of the prior art, as described, for example, in documents EP-B1-0 617 073 and FR-A-2 798 622, without affecting their thermal properties, which remain excellent.

In particular, the cured products prepared by heat treatment of the compositions according to the invention are more supple, more flexible and less brittle than the cured products prepared by heat treatment of the compositions according to the prior art containing a poly(ethynylene phenylene ethynylene silylene), and which, fundamentally, do not include any compound capable of exerting a plasticizing effect.

By virtue in particular of their fundamental characteristic, which is the presence of a compound capable of exerting a “plasticizing” effect, blended with the polymer, the compositions according to the invention afford a solution to the problems posed in the prior art and satisfy the needs listed above.

The preparation of such blends was not at all obvious to a person skilled in the art since the formulation of polymer compositions, with a view to modifying their properties, largely obeys random rules and varies very substantially from one family of polymers to another, to the extent that it was difficult, or even impossible, to envisage beforehand that the incorporation of compounds capable of exerting a plasticizing effect into the blend once this blend has been cured would lead to an improvement, mentioned above, in the mechanical properties, especially an increase in the suppleness and flexibility of the cured material, without, on the other hand, negatively affecting the other properties, for example the thermal properties, of these materials.

In a more detailed manner, the fundamental compound included in the blend of the composition of the invention is defined as a compound capable of exerting a plasticizing effect in the blend once this blend has been cured.

In general, the expression “compound capable of exerting a plasticizing effect in the blend, once this blend has been cured” means any compound that produces an increase (even minimal) in the “plastic” nature of the cured product—i.e. an increase in the deformability of the material consisting of the stressed cured product—compared with a cured product not containing said compound.

This especially means that, in the cured products prepared from the compositions according to the invention, the compound exerts an effect of reducing the rigidity and the hardness and, in contrast, of increasing the suppleness and the flexibility of the cured product, compared with a cured product including the same polymer but not containing said compound capable of exerting a plasticizing effect.

It is important to note that, according to the invention, the compound “capable of exerting a plasticizing effect” is not necessarily a “plasticizing” compound, as commonly defined, especially in the field of plastics and plastic processing.

In fact, this compound may be chosen from numerous compounds that are not generally commonly defined as being plasticizers, but which, in the context of the invention, are suitable compounds, in the sense that they exert a plasticizing effect in the cured product.

However, plasticizers known as such may also be used as said compound.

In other words, as has been seen above, since the cured products prepared from poly(ethynylene phenylene ethynylene silylene) are extremely hard, rigid and brittle, the inclusion into such a product of a compound that is relatively more supple than the polymer, although not conventionally classified as a “plasticizer”, is sufficient to afford an increase in the mobility of the polymer network and thus to exert a plasticizing effect.

The compound included in the blend, although not intrinsically being a “plasticizer”, does indeed act as a “plasticizer” in the final cured material.

The compound capable of exerting a plasticizing effect will thus generally be chosen from organic and mineral resins and polymers.

The organic polymers are generally chosen from thermoplastic polymers and thermosetting polymers.

The thermoplastic polymers may be chosen, for example, from fluoropolymers.

The thermosetting polymers may be chosen, for example, from epoxy resins, polyimides (poly(bismaleimides)), polyisocyanates, formaldehyde-phenol resins, silicones or polysiloxanes, and any other aromatic and/or heterocyclic polymers.

The “plasticizing” compound, such as a polymer, blended with the poly(ethynylene phenylene ethynylene silylene) and the latter may not be mutually miscible, or alternatively they may have a partial mutual miscibility, or alternatively they may be fully mutually miscible.

Preferably, the compound capable of exerting a plasticizing effect, such as a polymer, is a reactive compound, i.e. a compound capable of reacting with itself or with another compound capable of exerting a plasticizing effect or with the poly(ethynylene phenylene ethynylene silylene). Such reactive compounds, such as polymers, generally comprise at least one reactive function, chosen from acetylenic functions and hydrogenated silane functions.

Preferably, the reactive compound is chosen from hydrogenated silicone resins and polymers and/or silicone resins and polymers comprising at least one acetylenic function.

The silicone resins or polymers are chosen from silicone resins and polymers having the following formulae: 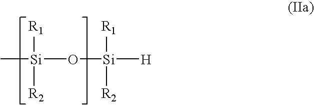
in which R₁ and R₂, which may be identical or different, represent an alkyl group of 1 to 10 C and especially a methyl group, and in which one or more of the hydrogen atoms borne by the silicon atoms and the carbon atoms may be replaced with a reactive group, such as an acetylenic group; 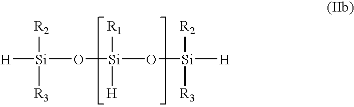
in which R₁, R₂ and R₃, which may be identical or different, represent an alkyl group of 1 to 10 C and especially a methyl group, and in which one or more of the hydrogen atoms borne by the silicon atoms and the carbon atoms may be replaced with a reactive group, such as an acetylenic group; 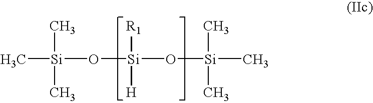
in which R₁ represents an alkyl group of 1 to 10 C and especially a methyl group, and in which one or more of the hydrogen atoms borne by the silicon atoms and the carbon atoms may be replaced with a reactive group, such as an acetylenic group; 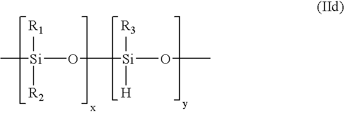
in which R₁, R₂ and R₃, which may be identical or different, represent an alkyl group of 1 to 10 C and especially a methyl group and in which one or more of the hydrogen atoms borne by the silicon atoms and the carbon atoms may be replaced with a reactive group, such as an acetylenic group, x and y represent the mole fraction of each of the units concerned and may vary between 0 and 1.

The molar mass of the compound(s) capable of exerting a plasticizing effect is generally between 200 and 10⁶ g/mol. It is thus noted that they can be either monomers, oligomers or polymers.

The amount of compound capable of exerting a plasticizing effect introduced during the formulation is between 0.1% and 200% of the mass of the poly(ethynylene phenylene ethynylene silylene silylene) and preferably between 10% and 50%, depending on the desired properties.

The poly(ethynylene phenylene ethynylene silylene) polymer incorporated into the blend is not particularly limited; it may be any polymer of this known type, and may in particular be poly(ethynylene phenylene ethynylene silylene) polymers described in documents EP-B1-0 617 073 and FR-A-2 798 662, of which the relevant parts relating to these polymers are included in the present text.

The polymer may thus, according to a first embodiment of the invention, correspond to formula (I) below: 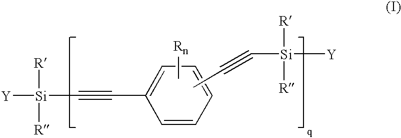
or to formula (Ia) below: 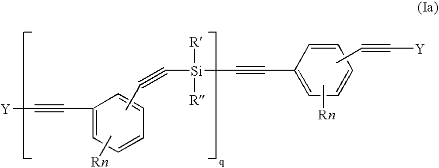
in which the phenylene group of the central repeating unit may be in the o, m or p form; R represents a halogen atom (such as F, Cl, Br or I), an alkyl group (linear or branched) containing from 1 to 20 carbon atoms, a cycloalkyl group containing from 3 to 20 carbon atoms (such as methyl, ethyl, propyl, butyl or cyclohexyl), an alkoxy group containing from 1 to 20 carbon atoms (such as methoxy, ethoxy or propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl or cyclohexenyl), an alkynyl group containing from 2 to 20 carbon atoms (such as ethynyl or propargyl), an amino group, an amino group substituted with one or two substituents containing from 2 to 20 carbon atoms (such as dimethylamino, diethylamino, ethylmethylamino or methylphenylamino) or a silanyl group containing from 1 to 10 silicon atoms (such as silyl, disilanyl (—Si₂H₅), dimethylsilyl, trimethylsilyl or tetramethyldisilanyl), one or more hydrogen atoms linked to the carbon atoms of R possibly being replaced with halogen atoms (such as F, Cl, Br or I), alkyl groups, alkoxy groups (such as methoxy, ethoxy or propoxy), aryl groups, aryloxy groups (such as a phenoxy group), amino groups, amino groups substituted with one or two substituents, or silanyl groups; n is an integer from 0 to 4 and q is an integer from 1 to 40; R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms or an alkynyl group containing from 2 to 20 carbon atoms, one or more of the hydrogen atoms linked to the carbon atoms of R′ and R″ possibly being replaced with halogen atoms, alkyl groups, alkoxy groups, aryl groups, aryloxy groups, amino groups, disubstituted amino groups or silanyl groups; examples of these groups have already been mentioned above for R; and Y represents a group derived from a chain-limiting agent.

The polymers according to this embodiment of the compositions of the invention, which are the polymers described in document FR-A-2 798 662, are substantially similar in structure to the polymers of document EP-B1-0 617 073, with the fundamental exception, however, of the presence at the chain ends of groups Y derived from a chain-limiting agent.

This structural difference has very little influence on the advantageous properties of these polymers, in particular the heat-stability properties of the polymer, which are virtually unaffected. On the other hand, the presence of this group at the chain ends has, specifically, the effect that the polymer of formula (I) or (Ia) has a determined, fully defined length and thus molecular mass.

Consequently, this polymer (I) or (Ia) also has fully defined and regulable Theological properties.

The nature of the group Y depends on the nature of the chain-limiting agent from which it is derived; in the case of the polymers of formula (I), Y may represent a group of formula (III): 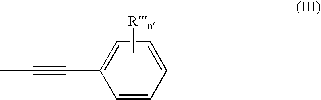
in which R′″ has the same meaning as R and may be identical to or different from R, and n′ has the same meaning as n and may be identical to or different from n.

Alternatively, in the case of the polymers of formula (Ia), Y may represent a group of formula (IV): 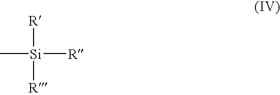
in which R′, R″ and R′″, which may be identical or different, have the meaning already given above.

One polymer of formula (I) that is particularly preferred corresponds to the following formula: 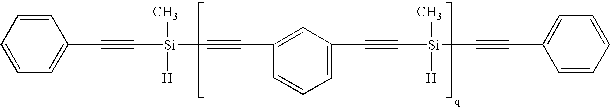
in which q is an integer from 1 to 40.

Other polymers that may be used in the compositions of the invention are polymers of given molecular mass, which are obtainable by hydrolysis of the polymers of formula (Ia) and which correspond to formula (Ib) below: 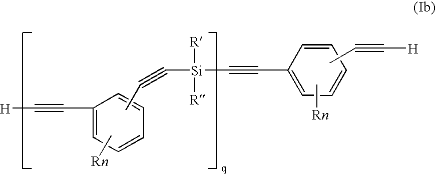
in which R, R′, R″, n and q have the meaning already given above.

The molecular mass of polymers (I), (Ia) and (Ib) according to this embodiment of the invention is fully defined and the length of the polymer and thus its molecular mass may be readily controlled by dosed additions of chain limiter to the reaction mixture, reflected by variable proportions of group Y in the polymer.

Thus, according to the first embodiment of the composition of the invention, the molar ratio of the groups Y at the end of the chain to the ethynylene phenylene ethynylene silylene repeating units is generally from 0.01 to 1.5. This ratio is preferably from 0.25 to 1.

Similarly, according to this first embodiment of the composition of the invention, the molar proportion of groups Y at the end of the chain is generally from 1% to 60% and preferably from 20% to 50% of the polymer of formula (I) or (Ia).

The number-average molecular mass of polymers (I), (Ia) and (Ib) according to this first embodiment of the composition of the invention, which is fully defined, is generally from 400 to 10 000 and preferably from 400 to 5 000, and the weight-average molecular mass is from 600 to 20 000 and preferably from 600 to 10 000.

According to a second embodiment of the composition of the invention, the poly(ethynylene phenylene ethynylene silylene) polymer included in the composition of the invention may be a polymer comprising at least one repeating unit, said repeating unit comprising two acetylenic bonds, at least one silicon atom, and at least one inert spacer group. Advantageously, said polymer also comprises, at the end of the chain, groups (Y) derived from a chain-limiting agent.

The term “inert spacer group” generally means a group that does not participate in or does not react during crosslinking.

The repeating unit of this polymer may be repeated n₃ times.

Fundamentally, the polymer, in this embodiment of the invention, comprises at least one repeating unit comprising at least one spacer group that is not involved in a crosslinking process, to which the polymer, in this embodiment of the invention, may be subsequently subjected.

The presence of such a spacer group in polymers of poly(ethynylene phenylene ethynylene silylene) type is not mentioned in the prior art. Surprisingly, this fundamental structural characteristic of the polymers according to this embodiment of the composition of the invention greatly improves the mechanical properties of the polymers without significantly modifying their thermal properties, which remain excellent.

Without wishing to be bound by any theory, the role of the spacer is especially to act as an inter-node crosslinking chain unit that is large enough to allow movements within the network.

In other words, the at least one spacer group serves spatially to space apart the triple bonds of the polymer, whether these triple bonds belong to the same repeating unit or to two different consecutive repeating units. The spacing between two triple bonds or acetylenic functions, provided by the spacer group, generally consists of linear molecules and/or of several linked aromatic nuclei, optionally separated by single bonds.

The spacer group defined above may be readily chosen by the man skilled in the art.

The choice of the nature of the spacer group also makes it possible to regulate the mechanical properties of the polymers of the invention, without significantly modifying the thermal properties.

The spacer group(s) may be chosen, for example, from groups comprising several aromatic nuclei linked via at least one covalent bond and/or at least one divalent group, polysiloxane groups, polysilane groups, etc.

When there are several spacer groups, there are preferably two of them, and they may be identical or chosen from all the possible combinations of two or more of the groups mentioned above.

Depending on the spacer group chosen, the repeating unit of the polymer according to the second embodiment of the composition of the invention may thus correspond to several formulae.

The polymer according to this second embodiment of the invention may be a polymer comprising a repeating unit of formula (V): 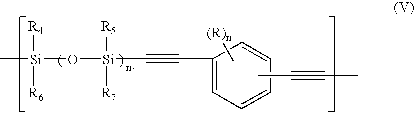
in which the phenylene group of the central repeating unit may be in the o, m or p form; R represents a halogen atom (such as F, Cl, Br or I), an alkyl group (linear or branched) containing from 1 to 20 carbon atoms, a cycloalkyl group containing from 3 to 20 carbon atoms (such as methyl, ethyl, propyl, butyl or cyclohexyl), an alkoxy group containing from 1 to 20 carbon atoms (such as methoxy, ethoxy or propoxy), an aryl group containing from 6 to 20 carbon atoms (such as a phenyl group), an aryloxy group containing from 6 to 20 carbon atoms (such as a phenoxy group), an alkenyl group (linear or branched) containing from 2 to 20 carbon atoms, a cycloalkenyl group containing from 3 to 20 carbon atoms (such as vinyl, allyl or cyclohexenyl), an alkynyl group containing from 2 to 20 carbon atoms (such as ethynyl or propargyl), an amino group, an amino group substituted with one or two substituents containing from 2 to 20 carbon atoms (such as dimethylamino, diethylamino, ethylmethylamino or methylphenylamino) or a silanyl group containing from 1 to 10 silicon atoms (such as silyl, disilanyl (—Si₂H₅), dimethylsilyl, trimethylsilyl and tetramethyl-disilanyl), or one or more hydrogen atoms linked to the carbon atoms of R, being optionally replaced with halogen atoms (such as F, Cl, Br and I), alkyl groups, alkoxy groups (such as methoxy, ethoxy and propoxy), aryl groups, aryloxy groups (such as a phenoxy group), amino groups, amino groups substituted with one or two substituents or silanyl groups; R₄, R₅, R₆ and R₇, which may be identical or different, represent a hydrogen atom; an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ possibly being replaced with halogen atoms, alkyl groups, alkoxy groups, aryl groups, aryloxy groups, amino groups, disubstituted amino groups or silanyl groups; examples of these groups have already been mentioned above for R, n is an integer from 1 to 4, and n₁ is an integer from 1 to 10 and preferably from 1 to 4; this repeating unit is generally repeated n₃ times, with n₃ being an integer, for example from 2 to 100.

Alternatively, the polymer according to the second embodiment of the composition of the invention may be a polymer comprising a repeating unit of formula: 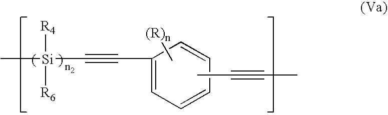
in which the phenylene group may be in the o, m or p form, and R, R₄, R₆ and n have the meaning already given above and n₂ is an integer from 2 to 10.

This repeating unit is generally repeated n₃ times, with n₃ being an integer, for example from 2 to 100.

Alternatively, the polymer according to this second embodiment of the composition of the invention may be a polymer comprising a repeating unit of formula: 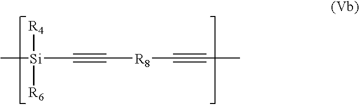
in which R₄ and R₆ have the meaning already given above, and R₈ represents a group comprising at least two aromatic nuclei comprising, for example, from 6 to 20 C, linked via at least one covalent bond and/or at least one divalent group, this repeating unit is generally repeated n₃ times, with n₃ being as defined above.

Alternatively, the polymer according to this second embodiment of the composition of the invention may be a polymer comprising a repeating unit of formula: 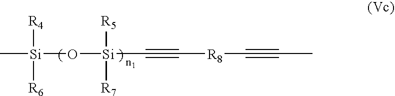
in which R₄, R₅, R₆, R₇, R₈ and n₁ have the meaning already given above, this repeating unit similarly possibly being repeated n₃ times.

Finally, the polymer according to this second embodiment of the composition of the invention may be a polymer comprising a repeating unit of formula: 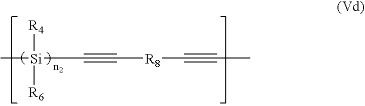
in which R₄, R₆, R₈ and n₂ have the meaning already given above, this unit possibly being repeated n₃ times.

In particular, in formulae (III), (IV) and (V) above, R₈ represents a group comprising at least two aromatic nuclei separated by at least one covalent bond and/or a divalent group.

The group R₈ may be chosen, for example, from the following groups: 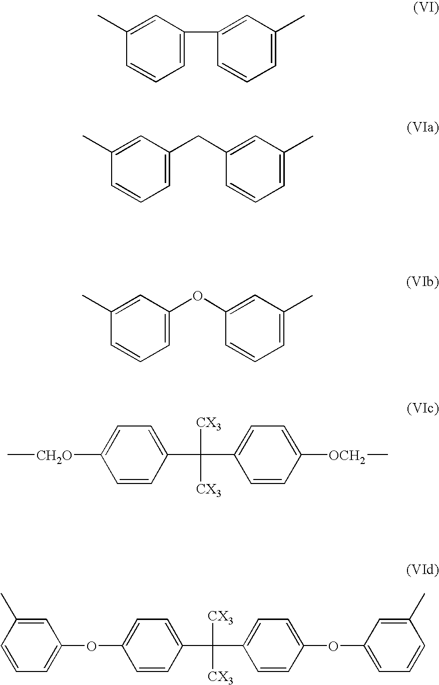
in which X represents a hydrogen atom or a halogen atom (F, Cl, Br or I).

Alternatively, the polymer according to this second embodiment of the invention may comprise several different repeating units comprising at least one inert spacer group.

Said repeating units are preferably chosen from the repeating units of formulae (V), (Va), (Vb), (Vc) and (Vd) already described above.

Said repeating units are repeated x₁, x₂, x₃, x₄ and x₅ times, respectively, in which x₁, x₂, x₃, x₄ and x₅ generally represent integers from 0 to 100 000, on condition that at least two from among x₁, x₂, x₃, x₄ and x₅ are other than 0.

This polymer having several different repeating units may optionally also comprise one or more repeating units not comprising an inert spacer group, such as a unit of formula (Ve):

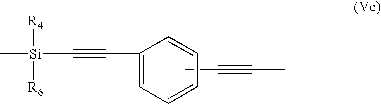

This unit is generally repeated x₆ times, with x₆ representing an integer from 0 to 100 000.

A preferred polymer corresponds, for example, to the formula: 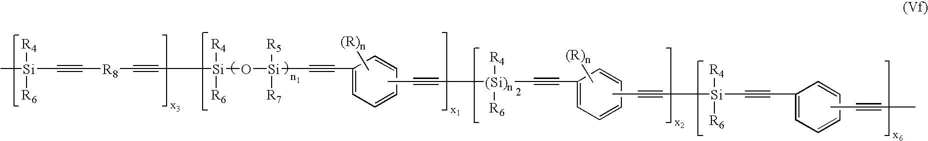
in which x₁, X₂, X₃ and x₆ are as defined above, on condition that two from among x₁, x₂ and X₃ are other than 0.

The polymers according to this second embodiment of the composition of the invention comprise, advantageously at the end of the chain, (end) groups (Y) derived from a chain-limiting agent, which makes it possible to control and regulate their length, their molecular mass and thus their viscosity.

The polymers according to this second embodiment of the composition of the invention, compared with the polymers of document EP-B1-0 617 073, are distinguished, especially, fundamentally due to the fact that at least one spacer group is present in the repeating unit.

These polymers of this second embodiment of the present invention can also be distinguished due to the fact that groups Y derived from a chain-limiting agent are present at the end of the chain.

These structural differences have very little influence on the advantageous properties of these polymers, in particular the heat-stability properties of the polymer, which are virtually unaffected.

On the other hand, the mechanical properties, such as the deformability or the breaking stress, are greatly improved by the presence of the spacer group(s).

In addition, the advantageous presence at the end of the chain of a chain-limiting group has the effect, precisely, that the polymer in this second embodiment of the invention has a determined, fully defined length and thus molecular mass.

Consequently, the polymer according to this second embodiment of the composition of the invention also advantageously has fully defined and regulable Theological properties.

The nature of the chain-limiting group Y depends on the nature of the chain-limiting agent from which it is derived; Y may represent a group of formula: 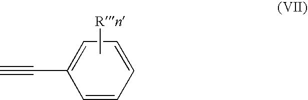
in which R′″ has the same meaning as R and may be identical to or different from the latter, and n′ has the same meaning as n and may be identical to or different from the latter.

Y may also represent a group of formula (VIII): 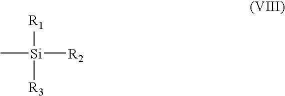
in which R₁, R₂ and R₃, which may be identical or different, have the meaning already given above.

The molecular mass of the polymers according to the invention is—due to the fact that they comprise a chain-limiting group—fully defined, and the length of the polymer and thus its molecular mass may be readily controlled by means of dosed additions of chain limiter into the reaction mixture, which is reflected by variable proportions of chain-limiting group Y in the polymer.

Thus, the molar ratio of the chain-limiting groups Y at the end of the chain to the repeating units of ethynylene phenylene ethynylene silylene type is generally from 0.01 to 1.5. This ratio is preferably from 0.25 to 1.

Similarly, according to the invention, the molar proportion of the chain-limiting groups Y if present at the end of the chain is generally from 1% to 60% and preferably from 20% to 50% of the polymer employed in this second embodiment of the composition according to the invention.

The number-average molecular mass of the polymers employed in this second embodiment of the composition according to the invention is generally from 400 to 100 000, and the weight-average molecular mass is from 500 to 1 000 000.

The number-average molecular mass of the polymers according to the invention is, due to the fact that they comprise a chain-limiting group, fully defined, and is generally from 400 to 10 000, and the weight-average molecular mass is from 600 to 20 000.

These masses are determined by gel permeation chromatography (GPC) via calibration with polystyrene.

By virtue of the fact that the polymer, in this second embodiment, advantageously contains chain-limiting groups, controlling the molecular mass of the polymers, which is generally in the range mentioned above, makes it possible to fully control the viscosity of the polymers.

Thus, the viscosities of the polymers employed in this second embodiment of the composition according to the invention are in a range of values from 0.1 to 1000 mPa.s for temperatures ranging from 20 to 160° C., within the mass range mentioned above.

The viscosity also depends on the nature of the groups borne by the aromatic rings and the silicon. These viscosities, which cannot be obtained with the polymers of the prior art, are entirely compatible with the standard techniques for preparing composites.

According to the invention, it is thus possible to modify the viscosity of the polymer as desired, as a function of the technological working constraints of the composite.

The viscosity is moreover associated with the glass transition temperature (Tg). The glass transition temperature of the polymers according to the invention will thus generally be from −250 to +10° C., which is very much lower than the glass transition temperatures of the polymers of the prior art.

The poly(ethynylene phenylene ethynylene silylenes) employed in the compositions of the invention can be prepared by all the known processes for preparing these polymers, for example the processes described in documents EP-B1-0 617 073 and FR-A-2 798 662.

In particular, the polymers (I) and (Ia) can be prepared by the process of document FR-A-2 798 662 and the polymers containing an inert spacer group can be prepared by processes analogous to those of documents EP-B1-0 617 073, and FR-A-2 798 662 if they comprise chain-limiting groups.

A first process for preparing a polymer included in the composition according to the invention, preferably of determined molecular mass, optionally bearing at the end of the chain groups derived from a chain-limiting agent, said polymer especially corresponding to formula (V), (Va), (Vb), (Vc) or (Vd) given above, comprises the reaction of a Grignard reagent of general formula: 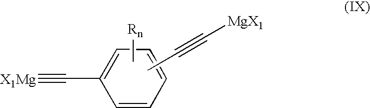
or of general formula: 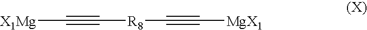
in which the phenylene group (formula (IX)) may be in the o, m or p form, and R, R₈ and n have the meaning given above, and X₁ represents a halogen atom such as Cl, Br, F or I (preferably, X₁ is Cl), optionally as a mixture with a chain-limiting agent, for example of formula:
Y—MgX₁ (XI)
X₁ having the meaning already given above, and Y is a group chosen from the groups of formula: 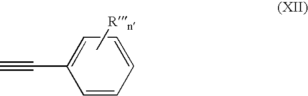
in which R′″ has the same meaning as R and may be identical to or different from the latter, and n′ has the same meaning as n and may be identical to or different from the latter;
with a dihalide (dihalosilane or dihalosiloxane) of formula (XIII) (a, b or c): 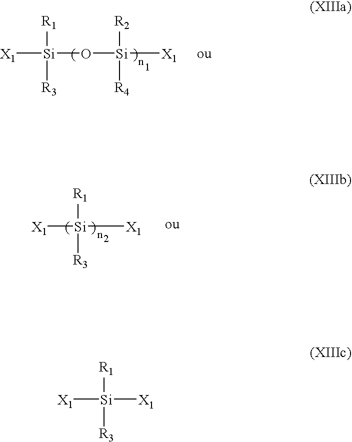
in which R₁, R₂, R₃ and R₄, which may be identical or different, X₁, n₁ and n₂ have the meaning already given above, X₁ preferably being Cl, in the presence of an aprotic solvent, followed by a hydrolysis step to give the final polymer of formula (V), (Va), (Vb), (Vc) or (Vd), respectively.

In other words, the polymers of formula (V), (Va), (Vb), (Vc) or (Vd), respectively, are obtained by reaction of (IX) and (XIIIa); (IX) and (XIIIb); (X) and (XIIIc), (XIIIa) and (XIIIb), respectively.

It will be noted that if the reaction involves a chain limiter, the hydrolysis is thus performed directly.

A second process for preparing a polymer of poly(ethynylene phenylene ethynylene silylene) type, preferably of determined molecular mass, optionally bearing at the end of the chain groups derived from a chain-limiting agent, said polymer corresponding in particular to formula (V), (Va), (Vb), (Vc) or (Vd) given above, comprises the reaction of a compound of formula (XIV): 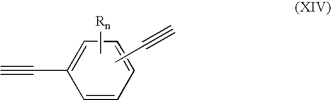
or of general formula: 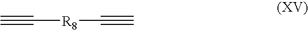
in which the phenylene group (general formula (XIV)) may be in the o, m or p form and R and n have the meaning already given above, optionally as a mixture with a chain-limiting agent, for example of formula (XVI): 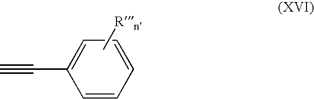
in which R′″ has the same meaning as R and may be identical to or different from the latter, and n′ has the same meaning as n and may be identical to or different from the latter, with a compound of formula (XVII) (a, b or c): 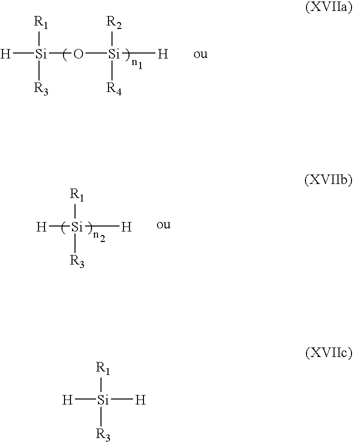
in which R₁, R₂, R₃ and R₄, which may be identical or different, and n₁ and n₂ have the meaning already given above, in the presence of a basic metal oxide, to give the final compound of formula (V), (Va), (Vb), (Vc) or (Vd), respectively.

In other words, the polymers of formula (V), (Va), (Vb), (Vc) or (Vd), respectively, are obtained by reaction of (XIV) and (XVIIa); (XIV) and (XVIIb) respectively; (XVII) and (XVIIc), (XVIIa) and (XVIIb), respectively.

According to the invention, and surprisingly, controlling the masses of the polymers according to the invention can preferably be obtained by adding to the reaction medium a reactive species, also known as a chain-limiting agent, which blocks the polymerization reaction without affecting the overall reaction yield.

Whether it is in the first process or in the second process, the length of the polymer and thus its molecular mass, and consequently its viscosity, are in direct correlation with the molar percentage of chain-limiting agent. This molar percentage is defined by the molar ratio of the chain-limiting agent to the total number of moles of chain-limiting agent and of diacetylenic compounds of formula (IX) or (X) or (XIII) or (XV)×100. This percentage may range from 1% to 60% and preferably from 20% to 50%.

The invention also relates to the cured product that may be obtained by heat-treating at a temperature generally from 50 to 500° C., the composition described above, optionally in the presence of a catalyst.

Finally, the invention also relates to a composite matrix comprising the polymer described above.

In detail, the process for preparing a polymer of poly(ethynylene phenylene ethynylene silylene) type may be that described in document EP-B1-0 617 073 in the case where the polymer does not have a chain-limiting agent, or alternatively it may be a process which is substantially analogous to that described in document EP-B1-0 617 073 and which is that described in document FR-A-2 798 662. This latter process, named “first preparation process” according to the invention, differs from the process of document EP-B1-0 617 073 by the incorporation into the mixture of a chain-limiting agent, by the final treatment of the polymers and possibly by the molar ratio of the organomagnesium and dichlorosilane reagents. As regards the conditions of this process, reference may thus be made to said document EP-B1-0 617 073, which is incorporated into the present patent by reference as well as to the document FR-A-2 798 662 which is also incorporated into the present patent by reference.

The Grignard reagents of formula (IX) used in the first preparation process according to the invention are especially those described in document EP-B1-0 617 073 on pages 5 to 7 (formulae (3) and (8) to (20)). The Grignard reagents of formula (X) are chosen, for example, from the compounds obtained from formulae (VI) to (VId).

The chain-limiting agent of formula (XI) may be a monoacetylenic organomagnesium compound of formula: 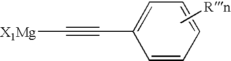
R′″, x₁ and n′ have already been defined above.

Examples of monohalosilanes used, for example, in the step preceding the hydrolysis are given in patent EP-B1-0 617 073 on page 9 (formula (5)).

Examples of the monoacetylenic compounds from which the monoacetylenic organomagnesium reagents (XI) are derived are the following: phenyl-acetylene, 4-ethynyl-toluene, 4-ethynylbiphenyl, 1-ethynyl-4-methoxybenzene.

The Grignard reagent (IX) or (X), as a mixture with the chain-limiting compound corresponding to the above formula, is reacted with a dihalosilane, reproduced in one of the general formulae (XIIIa) to (XIIIc).

Examples of such dihalosilanes (for example those of formula (XIIIb)) are the dichlorosilanes described on pages 7 to 9 of patent EP-B1-0 617 073 and correspond especially to formulae (21) to (26) given in said document.

The conditions of the polymerization reaction are such that the solvent, the reaction time, the temperature, etc. (with the exclusion of the “post-treatment”) are substantially the same as those described in document EP-B1-0 617 073 to which reference is made, in particular to page 14.

The only differences in this actual polymerization step concern the addition of an additional chain-limiting reagent. The reaction conditions are otherwise substantially the same.

However, and according to the invention, preferably, in the advantageous case in which [lacuna] is used, the ratio of the number of acetylenic functions to the number of halogen functions borne by the silane must be as close as possible to 1 and preferably from 0.9 to 1.1. The molar ratio of phenyl-acetylene to diethynylbenzene is preferably between 0.01 and 1.5 and ideally between 0.25 and 1 (percentage from 1% to 60%).

This also applies to the case of the variant of the first process in which the chain limiter is a monohalosilane.

According to the invention, due to the fact that a chain limiter is used, following the polymerization reaction, a final hydrolysis step is performed directly, and one step is thus dispensed with compared with the similar process of the prior art, in particular in the case in which the chain limiter is an organomagnesium reagent.

Specifically, in document EP-B1-0 617 073, a post-treatment is performed on the polymer already prepared, the molecular mass of which is set, with a monohalosilane followed by a hydrolysis. It should be noted that, in this case, the monohalosilane does not act as a chain limiter since, in contrast with the present invention, it is not included in the starting reaction mixture and its action has no influence on the molecular mass of the polymer.

According to the invention, at the end of the reaction, the polymer is hydrolyzed with a volume, for example from 0.1 to 50 ml per gram of polymer, of an acidic solution, for example about 0.01 to 10 N hydrochloric acid or sulphuric acid.

The ideal solvent is tetrahydrofuran. In this case, the reaction mixture is then decanted and the solvent of the organic phase is replaced with a volume, for example from 0.1 to 100 ml per gram of polymer and ideally from 1 to 10 ml per gram of polymer, of any type of water-immiscible solvent, such as xylene, toluene, benzene, chloroform, dichloromethane or an alkane containing more than 5 carbons. In the case of a reaction performed in a water-immiscible solvent, this step may be omitted. The organic phase is then washed, for example 1 to 5 times and preferably 2 to 3 times, with a volume of water, for example from 0.1 to 100 ml per gram of polymer and ideally from 1 to 10 ml per gram of polymer, so as to neutralize the organic phase and to extract therefrom all the impurities such as the magnesium salts and halogen salts. The pH of the organic phase should preferably be between 5 and 8 and ideally between 6.5 and 7.5. After evaporating off the solvent, the polymer is dried under a vacuum of between 0.1 and 500 mbar at a temperature of between 20 and 150° C. for a period of between 15 minutes and 24 hours.

The second process for preparing the polymers according to the invention is a process involving a dehydrogenation in the presence of a basic metal oxide.

Such a process differs essentially from the similar process described in documents [1] and [4] and also in document EP-B1-0 617 073 only in that a chain-limiting agent is added to the reaction mixture.

The reaction mixture comprises a compound of formula (XIV), for example: 1,3-diethynylbenzene or (XV), and a chain-limiting agent which is, in this second process, a monoacetylene (XVI) similar to that already described above for the first process.

Compound (XIV) or (XV), as a mixture with the chain-limiting agent, reacts with a dihydrosilane of formula (XVIIa) to (XVIIc).

The basic metal oxide used is preferably chosen from oxides of alkali metals or of alkaline-earth metals, lanthanide oxides and scandium, yttrium, thorium, titanium, zirconium, hafnium, copper, zinc and cadmium oxides, and mixtures thereof.

Examples of such oxides are given in document EP-B1-0 617 073 on pages 16 and 17, to which reference is explicitly made herein. These oxides may be subjected to an activation treatment as described in patent EP-B1-0 617 073.

The cured products prepared by heat-treating the compositions according to the invention are, for example, produced by first mixing the polymer and the “plasticizing” compound (in liquid form) and by melting this mixture; or alternatively by firstly dissolving the polymer and the plasticizing compound in a suitable solvent.

Then the composition is optionally placed in the desired form and it is heated in a gaseous atmosphere of air, of nitrogen or of an inert gas such as argon or helium.

The treatment temperature generally ranges from 50 to 500° C., preferably from 100 to 400° C. and more preferably from 150 to 350° C., and the heating is generally performed for a period of from one minute to 100 hours.

On account of the similar structure of the polymers according to the invention and of the polymers of document EP-B1-0 617 073, their curing process is substantially identical and reference may be made to page 17 of said document, as well as to document FR-A-2 798 622, for further details.

The composition of the invention, i.e. the composition comprising the blend of at least one poly(ethynylene phenylene ethynylene silylene) polymer and of at least one compound capable of exerting a plasticizing effect in the blend once this blend has been cured, in other words the “plasticized” poly(ethynylene phenylene ethynylene silylene) resin, may also be cured at temperatures below the heat-curing temperatures, under the action of a catalyst for Diels-Alder and hydrosilylation reactions. In particular, platinum-based catalysts, such as H₂PtCl₆, Pt(DVDS), Pt(TVTS) and Pt(dba), in which DVDS represents divinyldisiloxane, TVTS represents trivinyltrisiloxane and dba represents dibenzylidene acetone; and transition metal complexes, such as Rh₆(CO)₁₆ or Rh₄(CO)₁₂, ClRh(PPh₃), Ir₄(CO)₁₂ and Pd(dba), may be used for the catalysis of hydrosilylation reactions.

Catalysts based on transition metal pentachloride, such as TaCl₅, NbCl₅ or MoC₅, will themselves be advantageously used to catalyse reactions of Diels-Alder type.

The catalysis of these reactions makes it possible to use “plasticizing” compounds of low molecular mass and thus of low boiling point. These compounds will be readily chosen by a person skilled in the art from the compounds capable of exerting a plasticizing effect mentioned above. These “plasticizers” will advantageously be used to lower the viscosity of the blend before implementation.

The nature and structure of the cured materials or products obtained depend on the poly(ethynylene phenylene ethynylene silylene) polymer(s) and on the compound capable of exerting a plasticizing effect (which may also be a polymer) used.

It is thus possible to prepare polymer-polymer composite cured products or materials, consisting of a matrix of the polymer in which are dispersed nodules consisting of the compound exerting a plasticizing effect, such as an added (“plasticizing”) polymer. This case is especially encountered when the polymer and the plasticizing compound, such as a polymer, used are immiscible. The proportion of each constituent conditions the nature of the matrix and of the nodules.

It is also possible to obtain a material consisting of two separate matrices consisting, respectively, of the polymer and the compound exerting a plasticizing effect, the networks of which are interpenetrated such that no phase dissociation is perceptible. This case is especially encountered when the polymer(s) and the “plasticizing” compound, such as a polymer, used in the formulation are fully miscible and when the polymer(s) and the compound, such as a polymer, simultaneously form cured networks.

Finally, the cured material may also consist of a single network. This case is especially encountered when the polymer and the compound, such as a polymer, have possibilities of reacting with each other. In particular, reactive “plasticizing” compounds, such as polymers functionalized with acetylenic functions or functions with hydrogenated silanes, are capable of reacting in this way.

The preparation of composites with an organic matrix comprising the polymer of the invention may be performed via numerous techniques. Each user adapts it to his constraints. The principle is generally always the same: i.e. coating of a textile reinforcer with the resin, followed by crosslinking via heat treatment comprising a rate of temperature increase of a few degrees/minute, followed by a steady temperature close to the crosslinking temperature.

It should be noted that in the case described above, when it involves the presence of a cured polymer-polymer composite material, the presence of a textile reinforcement is not necessary.

The invention will now be described with reference to the following example, which is given as a non-limiting illustration.

### EXAMPLE

Plasticization of poly(methylene silylene ethynylene phenylene ethynylene) with hexamethyltrisiloxane

1. Principle

Poly(methylene silylene ethynylene phenylene ethynylene) is obtained by standard organomagnesium coupling reactions between a dihalo silane and the difunctional Grignard reagent of diethynylbenzene.

The viscosity of this polymer is adjusted by introducing phenylacetylene, in accordance with document FR-A-2 798 662 mentioned above. The plasticization of the poly(methylene silylene ethynylene phenylene ethynylene) is obtained by reaction with the trisiloxane compound, i.e. hexamethyltrisiloxane, under the catalytic effect of a platinum-based catalyst.

2. Implementation

2 g of hexamethyltrisiloxane and 50 mg of a THF solution containing H₂PtCl₆ at a concentration of 20 g/l are added to 10 g of poly(methylene silylene ethynylene phenylene ethynylene). The homogeneous mixture thus obtained is maintained at room temperature until it has gelled. The gel may then be brought to elevated temperature according to the standard conditions for non-plasticized polymers of this type.

After post-curing under temperature conditions that are suitable according to the applications, a cured material is obtained, whose mechanical properties are improved compared with the materials obtained without plasticizer.

By way of example, the cured materials obtained according to the above example in accordance with the invention especially have an elongation at break that is three times higher than that which may be measured on a non-plasticized material not in accordance with the invention.

### REFERENCES

[1] “New Highly Heat-Resistant Polymers containing Silicon: Poly(silyleneethynylenephenylene ethynylene)s” by ITOH M., INOUE K., IWATA K., MITSUZUKA M. and KAKIGANO T., Macromolecules, 1997, 30, pp. 694-701.
[2] CORRIU Robert J. P. et al., Journal of polymer science: Part C Polymer Letters, 1990, 28, pp. 431-437.
[3] “Copper [1] chloride catalyzed cross dehydrocoupling reactions between silanes and ethynyl compounds. A new method for the copolymerization of silanes and alkynes” by Liu H. Q.; HARROD J. F. The Canadian Journal of Chemistry, 1990, vol. 68, pp. 1100-1105.
[4] “A novel synthesis and extremely high Thermal stability of Poly[(phenylsilylene)-(ethynylene-1,3-phenylene ethynylene)]” by ITOH M., INOUE K., IWATA K., MITSUZUKA M., KAKIGANO T. Macromolecules, 1994, 27, pp. 7917-7919.
[5] KUROKI S.; OKITA K.; KAKIGANO T.; ISHIKAMA J. ITOH M.; Macromolecules, 1998, 31, 2 804-2 808.

1-46. (Canceled).

47. A composition comprising a blend of at least one poly(ethynylene phenylene ethynylene silylene) polymer and of at least one compound capable of exerting a plasticizing effect in the blend once the blend has been cured.

48. The composition according to claim 47, wherein the at least one compound capable of exerting a plasticizing effect is selected from organic and mineral resins and polymers.

49. The composition according to claim 48, wherein the organic polymers are selected from thermoplastic polymers and thermosetting polymers.

50. The composition according to claim 49, wherein the thermoplastic polymers are selected from fluoropolymers.

51. The composition according to claim 49, wherein the thermosetting polymers are selected from epoxy resins, polyimides (poly(bismaleimides)), polyisocyanates, formaldehyde-phenol resins, silicones or polysiloxanes.

52. The composition according to claim 49, wherein the thermosetting polymers are selected from aromatic and/or heterocyclic polymers.

53. The composition according to claim 47, wherein the at least one compound capable of exerting a plasticizing effect and the at least one poly(ethynylene phenylene ethynylene silylene) are not mutually miscible.

54. The composition according to claim 47, wherein the at least one compound capable of exerting a plasticizing effect and the at least one poly(ethynylene phenylene ethynylene silylene) are partially mutually miscible.

55. The composition according to claim 47, wherein the at least one compound capable of exerting a plasticizing effect and the at least one poly(ethynylene phenylene ethynylene silylene) are fully mutually miscible.

56. The composition according to claim 47, wherein the at least one compound capable of exerting a plasticizing effect is a reactive compound.

57. The composition according to claim 56, wherein the at least one compound capable of exerting a plasticizing effect comprises at least one reactive function selected from acetylenic functions and hydrogenated silane functions.

58. The composition according to claim 56, wherein the reactive compound is selected from hydrogenated silicone resins and polymers and/or silicone resins and polymers comprising at least one acetylenic function.

59. The composition according to claim 58, wherein the reactive compound is selected from polymers and resins having one of the following formulae: 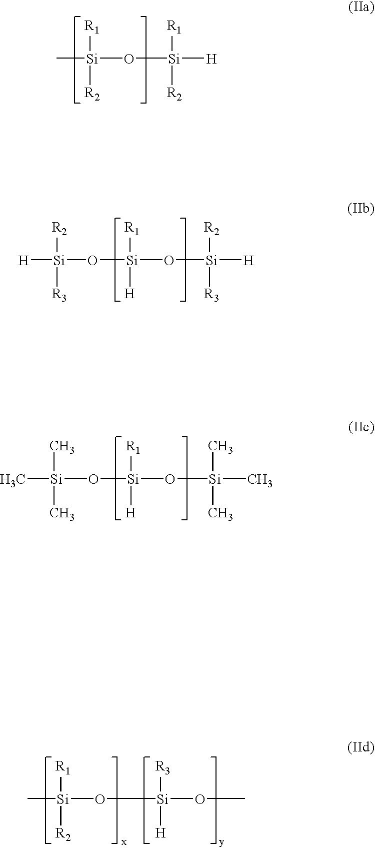
wherein R₁, R₂ and R₃, which may be identical or different, represent an alkyl group of 1 to 10 carbon atoms, one or more of the hydrogen atoms borne by the silicon atoms and the carbon atoms may be replaced with a reactive group, and x and y represent the mole fraction of each of the units concerned and may vary between 0 and 1.

60. The composition according to claim 47, wherein the molar mass of the compound(s) capable of exerting a plasticizing effect is between 200 and 106 g/mol.

61. The composition according to claim 47, wherein the amount of compound(s) capable of exerting a plasticizing effect is between 0.1% and 200% of the mass of the at least one poly(ethynylene phenylene ethynylene silylene).

62. The composition according to claim 61, wherein the amount of compound(s) capable of exerting a plasticizing effect is between 10% and 50% of the mass of the at least one poly(ethynylene phenylene ethynylene silylene).

63. The composition according to claim 47, wherein the at least one poly(ethynylene phenylene ethynylene silylene) polymer corresponds to formula (I) or formula (Ia) below: 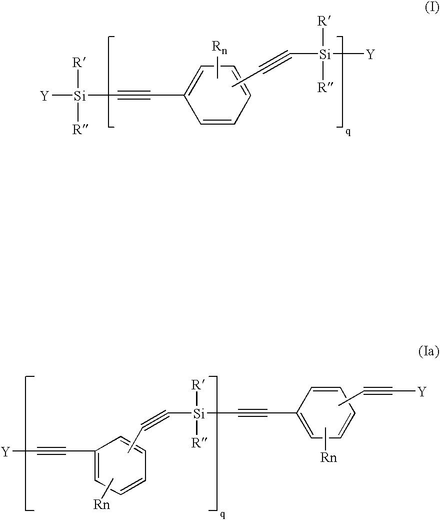
wherein
the phenylene group of the central repeating unit may be in the o, m or p form;
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon or a silanyl group containing from 1 to 10 silicon atoms, one or more hydrogen atoms linked to the carbon atoms of R optionally being replaced with halogen atoms, alkyl groups, alkoxy groups, aryl groups, aryloxy groups, amino groups, amino groups substituted with one or two substituents, or silanyl groups;
n is an integer from 0 to 4 and q is an integer from 1 to 40;
R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms or an alkynyl group containing from 2 to 20 carbon atoms, one or more of the hydrogen atoms linked to the carbon atoms of R′ and R″ optionally being replaced with halogen atoms, alkyl groups, alkoxy groups, aryl groups, aryloxy groups, amino groups, disubstituted amino groups or silanyl groups; and
Y represents a group derived from a chain-limiting agent.

64. The composition according to claim 63, wherein the polymer corresponds to formula (I) and Y represents a group of formula (III): 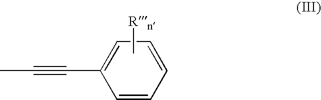
wherein R′″ has the same meaning as R and may be identical to or different from R, and n′ has the same meaning as n and may be identical to or different from n.

65. The composition according to claim 63, wherein the polymer corresponds to the formula (Ia) and Y represents a group of formula (IV): 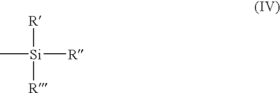
wherein
R′″ has the same meaning as R and may be identical to or different from R, and
R′, R″ and R′″ may be identical or different.

66. The composition according to claim 63, wherein the polymer corresponds to the following formula: 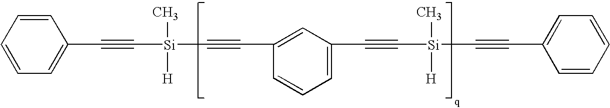
wherein q is an integer from 1 to 40.

67. The composition according to claim 47, wherein the at least one poly(ethynylene phenylene ethynylene silylene) polymer corresponds to formula (Ib): 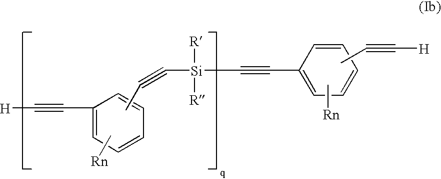
wherein
the phenylene group of the central repeating unit is in the o, m or p form;
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon or a silanyl group containing from 1 to 10 silicon atoms, one or more hydrogen atoms linked to the carbon atoms of R optionally being replaced with halogen atoms, alkyl groups, alkoxy groups, aryl groups, aryloxy groups, amino groups, amino groups substituted with one or two substituents, or silanyl groups;
n is an integer from 0 to 4 and q is an integer from 1 to 40; and
R′ and R″, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms or an alkynyl group containing from 2 to 20 carbon atoms, one or more of the hydrogen atoms linked to the carbon atoms of R′ and R″ optionally being replaced with halogen atoms, alkyl groups, alkoxy groups, aryl groups, aryloxy groups, amino groups, disubstituted amino groups or silanyl groups.

68. The composition according to claim 63, wherein the polymer has a molar ratio of the groups Y at the end of the chain to the ethynylene phenylene ethynylene silylene repeating units from 0.01 to 1.5.

69. The composition according to claim 68, wherein the polymer has a molar ratio of the groups Y at the end of the chain to the ethynylene phenylene ethynylene silylene repeating units from 0.25 to 1.

70. The composition according to claim 63, wherein the molar proportion of the groups Y at the end of the chain is from 1% to 60% of the polymer of formula (I) or (Ia).

71. The composition according to claim 70, wherein the molar proportion of the groups Y at the end of the chain is from 20% to 50% of the polymer of formula (I) or (Ia).

72. The composition according to claim 63, wherein the number-average molecular mass of the polymer of formula (I) or (Ia) is from 400 to 10 000 and the weight-average molecular mass is from 600 to 20 000.

73. The composition according to claim 72, wherein the number-average molecular mass of the polymer of formula (I) or (Ia) is 400 to 5000 and the weight-average molecular mass is from 600 to 10 000.

74. The composition according to claim 47, wherein the at least one poly(ethynylene phenylene ethynylene silylene) polymer is a polymer comprising at least one repeating unit, said repeating unit comprising two acetylenic bonds, at least one silicon atom, and at least one inert spacer group.

75. The composition according to claim 74, wherein said polymer further comprises groups (Y) derived from a chain-limiting agent.

76. The composition according to claim 74, wherein said inert spacer group of the polymer does not participate during crosslinking.

77. The composition according to claim 74, wherein said spacer group(s) of the polymer is (are) selected from groups comprising several aromatic nuclei linked via at least one covalent bond and/or at least one divalent group, polysiloxane groups, polysilane groups and any possible combination of two or more of these groups.

78. The composition according to claim 74, wherein said polymer is a polymer comprising a repeating unit of formula (V): 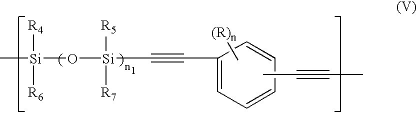
wherein
the phenylene group of the central repeating unit is in the o, m or p form;
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon atoms or a silanyl group containing from 1 to 10 silicon atoms, one or more hydrogen atoms linked to the carbon atoms of R being optionally replaced with halogen atoms, alkyl groups, alkoxy groups, aryl groups, aryloxy groups, amino groups, amino groups substituted with one or two substituents or silanyl groups;
R₄, R₅, R₆ and R₇, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups;
n is an integer from 1 to 4, and n₁ is an integer from 1 to 10; and
the repeating unit is repeated n₃ times, with n₃ being an integer from 2 to 100.

79. The composition of claim 78, wherein n₁ is an integer from 1 to 4.

80. The composition according to claim 74, wherein the polymer comprises a repeating unit of formula (Va): 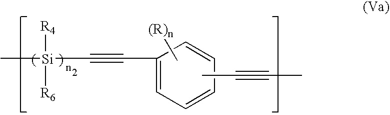
wherein
the phenylene group is in the o, m or p form,
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon atoms or a silanyl group containing from 1 to 10 silicon atoms, one or more hydrogen atoms linked to the carbon atoms of R being optionally replaced with halogen atoms, alkyl groups, alkoxy groups, aryl groups, aryloxy groups, amino groups, amino groups substituted with one or two substituents or silanyl groups;
R₄ and R₆, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups;
n is an integer from 1 to 4; and
n₂ is an integer from 2 to 10.

81. The composition according to claim 74, wherein the polymer comprises a repeating unit of formula: 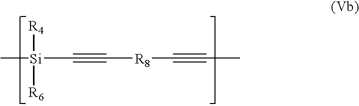
wherein
R₄ and R₆, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups; and
R₈ represents a group comprising at least two aromatic nuclei linked via at least one covalent bond and/or at least one divalent group.

82. The composition according to claim 81, wherein the least two aromatic nuclei comprise from 6 to 20 carbon atoms linked via at least one covalent bond and/or at least one divalent group.

83. The composition according to claim 74, wherein said polymer is a polymer comprising a repeating unit of formula: 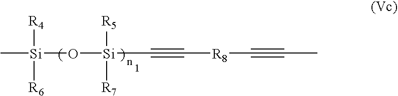
wherein
R₄, R₅, R₆ and R₇, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups;
R₈ represents a group comprising at least two aromatic nuclei linked via at least one covalent bond and/or at least one divalent group; and
n₂ is an integer from 2 to 10.

84. The composition according to claim 74, wherein said polymer is a polymer comprising a repeating unit of formula: 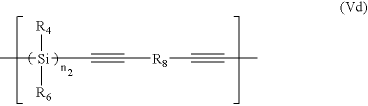
wherein
R₄ and R₆, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups; and
R₈ represents a group comprising at least two aromatic nuclei linked via at least one covalent bond and/or at least one divalent group; and
n₂ is an integer from 2 to 10.

85. The composition according to claim 81, wherein the group R₈ is selected from the group consisting of: 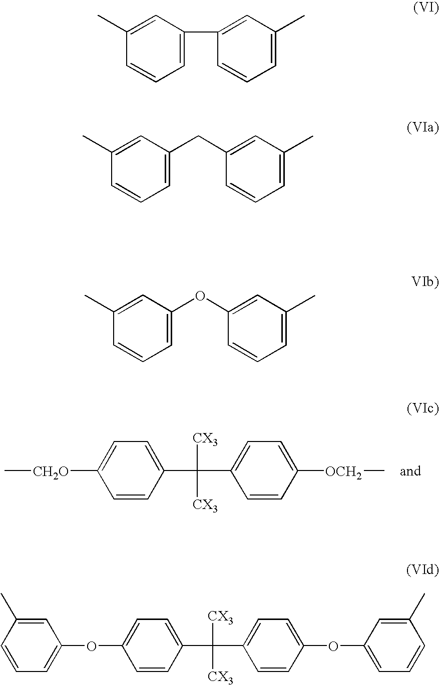
wherein X represents a hydrogen atom or a halogen atom.

86. The composition according to claim 83, wherein the group R₈ is selected from the group consisting of: 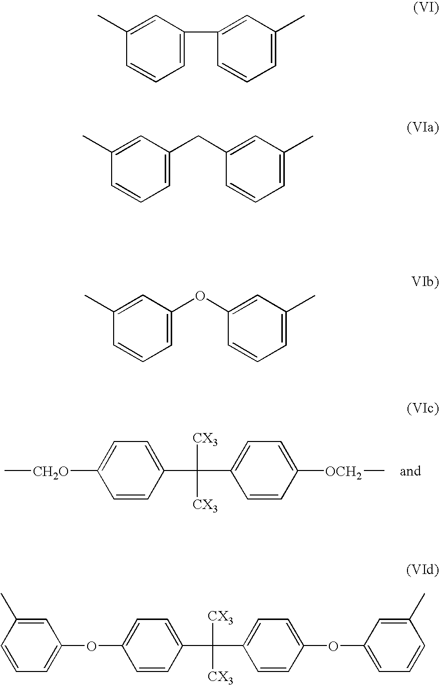
wherein X represents a hydrogen atom or a halogen atom.

87. The composition according to claim 84, wherein the group R₈ is selected from the group consisting of: 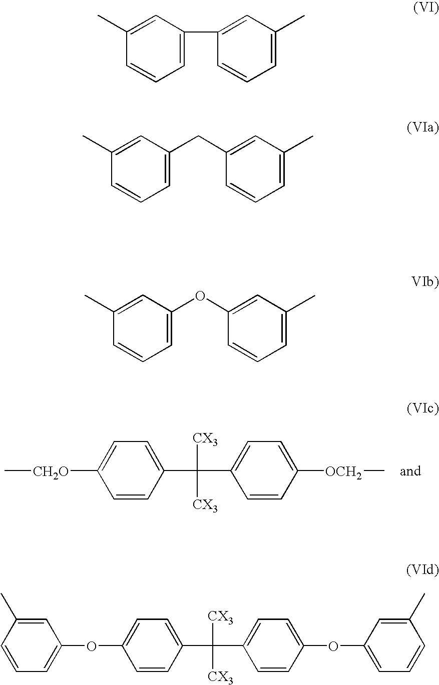
wherein X represents a hydrogen atom or a halogen atom.

88. The composition according to claim 74, wherein the polymer comprises a repeating unit repeated n₃ times, with n₃ being an integer from 2 to 100.

89. The composition according to claim 74, wherein the polymer comprises several different repeating units comprising at least one inert spacer group.

90. The composition according to claim 89, wherein said repeating units of the polymer comprising at least one inert spacer group are selected from the group consisting of the repeating units of formulae (V), (Va), (Vb), (Vc) and (Vd): 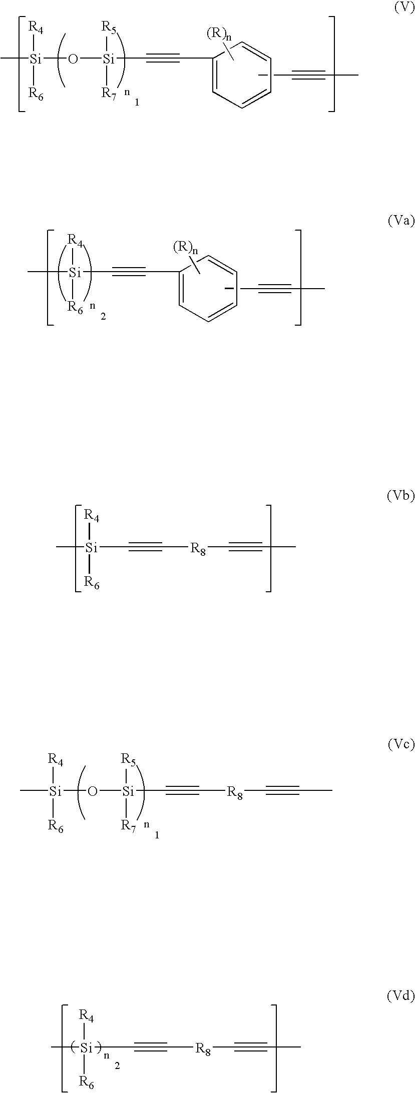
wherein
in formulae (V) and (Va), the phenylene group is in the o, m or p form;
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon atoms or a silanyl group containing from 1 to 10 silicon atoms, one or more hydrogen atoms linked to the carbon atoms of R being optionally replaced with halogen atoms, alkyl groups, alkoxy groups, aryl groups, aryloxy groups, amino groups, amino groups substituted with one or two substituents or silanyl groups;
R₄, R₅, R₆ and R₇, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups;
R₈ represents a group comprising at least two aromatic nuclei linked via at least one covalent bond and/or at least one divalent group;
n is an integer from 1 to 4;
n₁ is an integer from 1 to 10; and
n₂ is an integer from 2 to 10.

91. The composition according to claim 90, wherein said repeating units of the polymer are repeated, for the repeating units of formulae (V), (Va), (Vb), (Vc) and (Vd), xI, X₂, X₃, X₄ and x₅ times, respectively, xI, X₂, X₃, X₄ and x₅ representing integers from 0 to 100 000, with the proviso that at least two of x₁, x₂, X₃, x₄ and X₅ are other than 0.

92. The composition according to claim 74, wherein the polymer also comprises one or more repeating units not comprising an inert spacer group.

93. The composition according to claim 92, wherein said repeating unit of the polymer not comprising an inert spacer group corresponds to the formula: 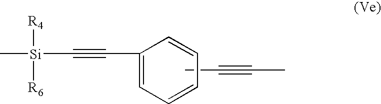
wherein R₄ and R₆, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R₅, R₆ and R₇ optionally being replaced with halogen atoms, alkyl groups, alkoxy groups, aryl groups, aryloxy groups, amino groups, disubstituted amino groups or silanyl groups.

94. The composition according to claim 92, wherein said repeating unit of the polymer not comprising an inert spacer group is repeated x₆ times, X₆ representing an integer from 0 to 100 000.

95. The composition according to claim 89, wherein the polymer corresponds to the formula: 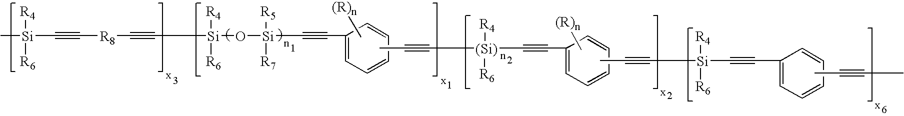
wherein
R represents a halogen atom, a linear or branched alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, a linear or branched alkenyl group containing from 2 to 20 carbon atoms, a cycloalkenyl group containing from 3 to 20 carbon atoms, an alkynyl group containing from 2 to 20 carbon atoms, an amino group, an amino group substituted with one or two substituents containing from 2 to 20 carbon atoms or a silanyl group containing from 1 to 10 silicon atoms, one or more hydrogen atoms linked to the carbon atoms of R being optionally replaced with halogen atoms, alkyl groups, alkoxy groups, aryl groups, aryloxy groups, amino groups, amino groups substituted with one or two substituents or silanyl groups;
R₄, R₅, R₆ and R₇, which may be identical or different, represent a hydrogen atom, an alkyl group containing from 1 to 20 carbon atoms, a cycloalkyl group containing from 3 to 20 carbon atoms, an alkoxy group containing from 1 to 20 carbon atoms, an aryl group containing from 6 to 20 carbon atoms, an aryloxy group containing from 6 to 20 carbon atoms, an alkenyl group containing from 2 to 20 carbon atoms, a cycloalkenyl group containing from 3 to 20 carbon atoms, or an alkynyl group containing from 2 to 20 carbon atoms, one or more of the hydrogen atoms linked to the carbon atoms of R₄, R, R₆ and R₇ optionally being replaced with halogen atoms, alkyl groups, alkoxy groups, aryl groups, aryloxy groups, amino groups, disubstituted amino groups or silanyl groups;
R₈ represents a group comprising at least two aromatic nuclei linked via at least one covalent bond and/or at least one divalent group;
n is an integer from 1 to 4;
n₁ is an integer from 1 to 10;
n₂ is an integer from 2 to 10;
x₁ is an integer from 0 to 100,000;
x₂ is an integer from 0 to 100,000;
x₃ is an integer from 0 to 100,000; and
x₆ is an integer from 0 to 100,000.

96. The composition according to claim 89, wherein the polymer has a number-average molecular mass from 400 to 10 000 and a weight-average molecular mass from 500 to 1 000 000.

97. A cured product produced by the method of heat-treating, at a temperature from 50 to 500° C., a composition, optionally in the presence of a catalyst selected from the group consisting of a Diels-Alder and hydrosilylation reaction catalyst, the composition comprising a blend of at least one poly(ethynylene phenylene ethynylene silylene) polymer and of at least one compound capable of exerting a plasticizing effect in the blend once the blend has been cured.

98. The cured product according to claim 97, consisting of a matrix of poly(ethynylene phenylene ethynylene silylene) polymer in which are dispersed nodules consisting of the compound that exerts a plasticizing effect.

99. The cured product according to claim 97, consisting of two separate matrices consisting respectively of the polymer and the compound exerting a plasticizing effect, the matrices having networks which are interpenetrated.

100. The cured product according to claim 97, consisting of a single network.

101. A composite matrix comprising a composition comprising a blend of at least one poly(ethynylene phenylene ethynylene silylene) polymer and of at least one compound capable of exerting a plasticizing effect in the blend once the blend has been cured.
